(19) United States
(12) Patent Application Publication
(10) Pub. No.: US 2016/0184752 A1
(43) Pub. Date: Jun. 30, 2016

(54) Filter Bag for a Vacuum Cleaner and Method for Identifying an Area of a Vacuum Cleaner Bag Directly Subjected to Flow

(71) Applicant: EUROFILTERS N.V., Overpelt (BE)

(72) Inventors: Ralf SAUER, Overpelt (BE); Jan SCHULTINK, Overpelt (BE)

(73) Assignee: Eurogilters Holding N.V., Overpelt (BE)

(21) Appl. No.: 14/910,905

(22) PCT Filed: Aug. 8, 2014
(86) PCT No.: PCT/EP2014/067049

§ 371 Date: Feb. 8, 2016

(30) Foreign Application Priority Data
Aug. 9, 2013 (EP) 13179851.4

(51) Int. Cl. B01D 39/16; B01D 46/02

(52) U.S. Cl. CPC B01D 39/1623; B01D 46/02

(57) ABSTRACT

The present invention relates to a filter bag for a vacuum cleaner which is formed from a filter material which comprises at least three filter material layers. In the case of the filter material layers, at least one layer is thereby a scrim and at least one layer a nonwoven fibre layer which comprises non-joined staple fibres and/or non-joined filaments.

The present invention relates to a filter bag for a vacuum cleaner which is formed from a filter material which comprises at least three filter material layers. In the case of the filter material layers, at least one layer is thereby a scrim and at least one layer a nonwoven fibre layer which comprises non-joined staple fibres and/or non-joined filaments. The filter bag comprises in addition an inlet opening, via which air can flow into the filter bag. The filter bag according to the present invention is distinguished by the fact that, in one region of the filter bag, in particular where the air flow entering through the inlet opening into the vacuum cleaner filter bag impacts directly on the filter material, at least one joint is present, in the case of which the at least one nonwoven fibre layer is joined to at least one of the at least two further layers so that a permanent fixing of the staple fibres and/or filaments of the nonwoven fibre layer to at least one of the at least two further layers is ensured. This region thereby constitutes at most 20% of the entire throughflow surface of the filter bag. The proportion of the compressed surface area of this joint, relative to the surface, is thereby between 0.1 and 40%. In the remaining regions or surfaces of the filter bag, joints of the non-joined fibres or filaments can likewise be present, however these joints are optional there. In every case, the proportion of compressed surface area of the joints in the remaining surfaces is hence smaller than in the region or regions.

Vacuum cleaner filter bags having multilayer filter materials, in the case of which for example a layer of filter materials has non-joined nonwoven fibre layers, are known from the state of the art, for example from EP 1 795 247 and EP 1 960 084. It was hereby found that the vacuum cleaner filter bags have a dust storage capacity which is all the better, the fewer weld points there are for joining the layers of the filter material of the vacuum cleaner filter bag.

However, it is disadvantageous with such filter bags with very few weld points that the filter material has less mechanical stability and hence can be damaged in the case of high inflow speeds of the air flow in the vacuum cleaner filter bag. In particular in the impact region of the air flow or of the particles transported with the air flow onto the filter material, the non-joined fibres of the nonwoven fibre layer, for example the loose staple fibres, are displaced, consequently the filter material layer situated below, for example the fine filter layer or a scrim, is exposed.

As a result of the lack of pre-filter function, this filter material then rapidly becomes clogged, it is often destroyed even by the air- or particle flow.

To date, such problems from the state of the art have been solved by impact-protection means, such as for example reinforcing inserts, being fitted on the inside of the vacuum cleaner filter bag. A generally large-area glueing or welding of a relatively rigid and mechanically stable impact-protection means to the inside of the region in which the air flow impacts directly on the wall of the filter material was hereby effected. For example, perforated or non-perforated foils, nonwoven fabrics or pieces of paper are thereby glued or welded onto this region. For example, EP 1 415 699 describes various variants of such protective items applied on a partial surface. In EP 2 510 859, a piece of material with a corresponding impact-protection function is described. DE 20 2004 019 344 describes a reinforcing layer made of foamed material or nonwoven plastic fibre material which is fitted opposite the inlet opening. DE 2009 002 970 discloses a similar impact means with an impact surface.

However, this involves the disadvantage that, in the region of the impact-protection means, there is no longer any air-permeability of the filter material so that an increased pressure drop arises in the vacuum cleaner filter bag. As a result, the storage capacity of the filter material is likewise greatly reduced so that overall the performance of the filter bag is noticeably reduced. In addition, non-uniform distribution of the incoming dust particles is effected in the filter bag, which impairs the service life permanently.

Starting herefrom, it is the object of the present invention to indicate a vacuum cleaner filter bag which has a high dust-storage capacity, a long service life and a low pressure loss. In addition, it is the object of the present invention to indicate a method with which the impact region of an air flow (=surface or region subjected directly to a flow) entering into the vacuum cleaner filter bag onto the filter material can be determined and investigated precisely.

This object is achieved, with respect to a filter bag, by the features of patent claim 1, with respect to a method for determining the region or, in the case where a plurality of regions is present, the regions subjected directly to a flow by the air flow entering through the inlet opening into the interior of the filter bag, by the features of patent claim 21. The dependent patent claims thereby represent advantageous developments.

According to the present invention, a filter bag for a vacuum cleaner is hence indicated, comprising a bag made of a filter material which comprises at least three filter material layers, at least one layer of which is a scrim and at least one layer a nonwoven fibre layer, comprising staple fibres and/or filaments, and also an inlet opening introduced in the bag.

According to the invention, it is thereby provided that the complete throughflow region of the filter material is subdivided into two qualitatively different regions. In one region, or a plurality of regions, which, taken together constitutes or constitute at most 20% of the throughflow surface of the filter bag and also possibly an additional region which surrounds the previously mentioned region directly, or in the case where a plurality of regions is present, a plurality of additional regions which respectively surround the region X directly, one or more joints of the filter material are thereby present. At the joint or in the case where a plurality of joints is present, the at least one nonwoven fibre layer is thereby joined at least to one of the at least two layers of scrim. As a result, it is ensured that, during operation of the filter bag, a permanent fixing of the staple fibres and/or filaments of the nonwoven fibre layer to the at least one further of the at least two further layers of scrim is ensured. The remaining regions or remaining surfaces hence constitute at least 80% of the throughflow surface of the filter bag. According to the invention, it is now provided that the proportion of compressed surface area of the joints in the previously defined region or regions which constitutes or constitute at most 20% of the throughflow surface of the filter bag and possibly in addition in the additional regions which constitute at most 80% of the surface of the region, is of 0.1 to 40% and is greater than in the remaining surfaces or regions.

In the remaining surfaces, the individual filter material layers of the filter bag can also be completely non-joined.

According to the present invention, it is hence provided to stabilise, merely in one region of the vacuum cleaner bag, the nonwoven fibre layer with at least one further material layer by means of joints, an increased density of joints being chosen in this region so that the proportion of compressed surface area of joints in this region and also possibly in additional regions surrounding the region is increased.

According to a preferred embodiment, the region or regions are located wherever an air flow entering through the inlet opening into the interior of the filter bag impacts directly on the filter material, which hence represents a region or regions subjected directly to a flow.

Underlying the present invention is hence the knowledge that at least three-layer filter materials, which comprise at least one layer of fibre nonwoven fabric, have excellent dust-storage capacity, however because of the loose fibres which are contained in the nonwoven fibre layer, have reduced mechanical stability. In particular in the region in which direct impact of the air flow or of the dust particles transported with the air flow is effected, mechanical damage, in particular to the nonwoven fibre layer, can be effected in the course of the vacuum cleaner operation by the loose fibres of the nonwoven fibre layer being displaced or blown away by the air flow passing through the filter material. This leads to the above-mentioned problems, as a result of which the service life and the separating capacity of the vacuum cleaner filter bag are impaired.

It is now crucial with the filter bag according to the present invention that at least the nonwoven fibre layer, i.e. the filter layer of the vacuum cleaner filter bag in which loose and non-joined staple fibres or filaments are present, is joined to at least one of the further layers so that a permanent fixing of the staple fibres or of the filaments of the nonwoven fibre layer to at least one of the further layers is ensured. This joint is thereby configured preferably at least in the region or the surface of the filter material which is subjected to a direct flow by the air flow entering into the filter bag, i.e. in a region in which the air flow entering into the vacuum cleaner filter bag impacts directly and quasi-unchecked on the filter material. This region of the vacuum cleaner filter bag represents the region of highest mechanical loading.

Surprisingly, it was found that, in the case of filter bags with a loose fibre layer (nonwoven fibre layer), it is completely adequate for mechanical stabilisation of the vacuum cleaner filter bag to stabilise, e.g. merely the highest-risk regions, by means of joints, for example welds. As a result, an effective mechanical fixing of the loose fibres is achieved so that these can no longer be displaced by the incoming air flow and remain at the intended place even with fairly strong mechanical loading by the air flow. As a result, a vacuum cleaner filter bag which has an excellent service life with, at the same time, a very high dust-storage capacity is produced. At the same time, the impact-protection means known from the state of the art can hence be dispensed with so that the problem of the high pressure loss in the vacuum cleaner filter bag can likewise be avoided. By omitting the impact-protection means, production of the vacuum cleaner bag is likewise simplified and more economical.

Preferably, firstly the region or, in the presence of a plurality of regions, the regions is or are therefore determined in which the air flow impacts directly and in which hence mechanical damage can occur. In these regions, according to the invention, fixing of the loose fibres is effected by joints in the case of which the loose fibres of the nonwoven fibre layer are joined to at least one of the further layers. As a result, mechanical damage by the air flow is prevented.

The method for determining the region or, if present, plurality of regions subjected directly to a flow is described in more detail further on and likewise corresponds to a concept according to the invention.

According to the present invention, it is now provided that, in the above-defined region or regions, in particular in the regions or surfaces of the vacuum cleaner filter bag subjected directly to a flow, a higher density of joints is provided than in the remaining regions of the vacuum cleaner filter bag, i.e. the proportion of the compressed surface area (this is the proportion which constitutes the surface area of the joints, relative to the surface subjected directly to a flow) is higher than in the remaining regions of the vacuum cleaner filter bag. It was detected according to the invention that the proportion of the compressed surface area in this region, preferably in the surface subjected directly to a flow or in the surfaces subjected directly to a flow, of 0.1 to 40% is adequate to prevent completely mechanical damage to the nonwoven fibre layer.

A further improvement and increase in the mechanical stability can be achieved by joints being provided not only in this region, e.g. in the region subjected directly to a flow or regions subjected directly to a flow, but also in regions which abut directly on this region and surround the latter.

In a preferred embodiment, the proportion of compressed surface area of the one or more joints in the initially defined region or regions, in particular in the region subjected directly to a flow or in each of the regions subjected directly to a flow and also possibly in the additional region or additional regions, is of 0.25 to 20%, particularly preferably of 0.5 to 10%.

Preferably, the surface area of the additional region which abuts on the above-defined region or regions is 10 to 80%, further preferably 20 to 70%, particularly preferably 30 to 60%, of the surface area of the initially defined region.

The additional region is thereby advantageously disposed concentrically about the above-defined region, e.g. the region subjected directly to a flow, and can for example have a circular or oval configuration or be adapted to the geometric shape of the region subjected directly to a flow.

According to a further preferred embodiment, the at least one nonwoven fibre layer is joined to at least one of the at least two further layers of scrim in the remaining surfaces, with the proviso that, relative to the total throughflow surface of the filter bag in the remaining surfaces, the proportion of compressed surface area of the one or of the sum of a plurality of joints is at most 5% of the throughflow surface of the filter bag in the remaining surfaces and, on average, at most 10 joints per 10 cm² are present.

The filter material of the vacuum cleaner can hence be formed analogously to that forming the basis of patent applications EP 1 795 247 and EP 1 960 084. With respect to the filter material which can be used for the filter bag according to the present invention, reference is made in particular to these two previously described European patent applications. In particular with respect to the material definition of a scrim or a nonwoven fibre layer, reference is thereby made to EP 1 795 247 A1. All of the definitions with respect to the terminology used “nonwoven fabric layer”, “nonwoven fibre layer”, “staple fibre” and also “filaments” are used identically in the definition of the present invention to those also forming the basis of EP 1 795 247 A 1.

In addition to the embodiments of the state of the art, i.e. EP 1 795 247 and EP 1 960 084, it can likewise be provided in the present invention that the individual filter material layers—with the exception of the initially defined region or regions—are not joined, i.e. for example not joined by weld points, so that there is no welded joint between the individual filter material layers, i.e. it is likewise possible as an alternative that the at least one nonwoven fibre layer is not joined to the further layers of scrim in the remaining surfaces.

According to an advantageous embodiment, in the initially defined region or regions, in particular in the region subjected directly to a flow or in the regions subjected directly to a flow and also possibly in the additional region or additional regions, the one or more joints are configured to be bar-shaped, cruciate, star-shaped, punctiform or linear and/or circular.

According to a particularly preferred embodiment, in the initially defined region or regions, in particular in the region subjected directly to a flow or in the regions subjected directly to a flow and also possibly in the additional region or additional regions, a plurality of punctiform or bar-shaped joints is present, which are disposed in a plurality of concentric circles.

In the remaining surfaces of the filter bag according to the present invention, it is preferred if on average at most 5, preferably at most 2, further preferably at most 1, further preferably at most 0.8, further preferably at most 0.6, in particular at most 0.3, joints per 10 cm² are present and/or the proportion of compressed surface area of the joints in the remaining surfaces is at most 2%, preferably at most 1%, of the surface of the throughflow surface of the filter bag in the remaining surfaces.

It is thereby advantageous that the scrim has a basis weight of 3 to 50 g/m².

There is understood, according to the present invention, by a scrim, in particular a netting, in particular a woven, extruded or fibrillated netting, a perforated foil, weldable paper, in particular teabag paper, and also any type of nonwoven fabric, in particular wet-laid, dry-laid or extruded nonwoven fabric.

According to the present invention, it is not necessary that the filter bag has impact-protection means and/or reinforcing inserts in the initially defined region or regions, in particular in the region or regions subjected directly to a flow and also possibly in the additional region or in the additional regions. According to the present invention, the previously mentioned impact-protection means can be entirely dispensed with. As a result, a high pressure loss at the respective impact-protection means is avoided.

The joints both in the additional regions and in the remaining surfaces (if present) can be effected in particular by welded joints, preferably ultrasonic welded joints or thermal welded joints, or by adhesive joints, or by sewing together at least the nonwoven fibre layer and at least one scrim layer.

It is thereby advantageous in particular if the nonwoven fibre layer is embedded between two scrim layers and all of these three layers are joined together at the joints. This can be effected for example advantageously by means of an ultrasonic welded joint, e.g. by ultrasound calendering. This joining technology can be applied both in the surface/surfaces subjected directly to a flow, in the additional regions and in the remaining regions of the filter bag.

The previously mentioned preferred embodiments relating to the nature and production of the joints are applicable for all of the joints which are produced in the vacuum cleaner filter bag according to the invention, i.e. for all of the joints which are disposed in the surface or surfaces subjected directly to a flow, in the additional joined regions which are disposed around the surfaces subjected directly to a flow, but can also occur in the remaining regions of the vacuum cleaner filter bag.

Further advantageously, the filter material comprises, e.g. on the outflow side, at least one further filter material layer, e.g. a meltblown layer and/or a spun nonwoven fabric layer. Preferably, all of the filter material layers are joined together at the joints.

Furthermore, it is possible that the inlet opening can have a deflection device via which the flow direction of the air flow entering into the interior of the filter bag is changed. With such a deflection device, for example a change in flow direction into the interior of the filter bag by several 10°, for example up to 90° is possible. Likewise it is possible that a sealing flap is fitted at the inlet opening. The previously mentioned devices can influence the position of the region subjected directly to a flow. In the case where a deflection device is fitted at the inlet opening, the direction of the air flow entering into the vacuum cleaner filter bag is hence changed. In this case, the region subjected directly to a flow is situated of course within the vacuum cleaner filter bag at the place at which the deflected air flow impacts on the interior wall of the vacuum cleaner filter bag. Hence the joint of the at least two material layers of the filter material should be chosen at the corresponding place.

In addition to or alternatively to the previously mentioned embodiments, it is likewise possible that the filter bag comprises at least one flow divider which subdivides the air flow entering through the inlet opening into the interior of the filter bag into at least two partial flows with a different main flow direction. In the case where a flow divider is present, it can be provided that a plurality of regions subjected directly to a flow result and are subjected to a flow by respectively one partial flow—resulting from the flow divider. In this case, it is preferred if a region subjected directly to a flow is assigned to each partial flow and a corresponding joint, i.e. one or more joints at the determined places, i.e. the regions subjected directly to a flow, is present. Hence the filter material in each region of a respective partial flow subjected directly to a flow and also possibly in addition in a region which surrounds the respective region subjected directly to a flow, has one or more joints.

However, it can likewise be possible that a corresponding device, as previously mentioned, for example deflection devices or flow dividers, are introduced at the connection piece of the vacuum cleaner itself, the connection piece being introduced via the inlet openings into the vacuum cleaner filter bag. The method according to the invention, which is given further on, for determining the regions subjected directly to a flow in a vacuum cleaner filter bag likewise makes it possible, with correspondingly designed vacuum cleaner connection pieces with which the air is blown into the vacuum cleaner filter bag, to determine those surfaces or regions which are subjected directly to a flow by the respective air flows.

According to a particularly preferred embodiment, it can be provided for example that the filter bag is configured as a flat bag or as side-folding flat bag. In the case of a flat bag, two, e.g. rectangular, filter material layers (with respectively in total at least three, e.g. five layers) are placed one upon the other and joined together at the edges, for example welded together. The two filter material layers thereby represent respectively one side of the filter bag. In the case of a side-folding bag, the filter bag is likewise formed by two filter material layers joined together, however the two filter material layers are inserted on two opposite sides, as a result of which an internal fold is formed, which fold can be turned out in the operating state. The first filter material layer thereby has an inlet opening. The second filter material layer has a region opposite for example the inlet opening which represents preferably the region subjected directly to a flow. A plurality of joints is hereby formed, in which the material layers of the filter material are welded together. This region has a surface area which constitutes at most 20% of the total throughflow surface area of the filter bag. The proportion of compressed surface area of the welded joints is thereby higher in this region than in the remaining regions of the filter material.

However also further geometric embodiments of the filter bag are conceivable and likewise preferred. In the case where the vacuum cleaner filter bag can be configured for example as pad base- or block bottom bag, it can be provided that the filter bag has a rectangular cross-section, the filter bag hence has four walls which are formed from the corresponding filter material. In such a case, it can be provided for example that the air flow from the vacuum cleaner itself is blown into the vacuum cleaner filter bag by means of a connection piece, this connection piece can likewise have a deflection means for the blown-in air flow. In this case, it is preferred if, at least on the side on which for example the air flow impacts directly, e.g. because of the deflection device (i.e. on which a surface subjected directly to a flow is present), a corresponding joint of the individual material layers of the filter material as defined above is present. Filter bags made of nonwoven materials which have shapes corresponding to the standard block- or pad base bags made of filter paper are known for example from DE 20 2009 004 433 U 1 and DE 20 2005 016 309 U 1. Likewise, a pleated form of the filter bag is conceivable, such filter bags are defined for example in EP 2 366 319. The disclosure content of this application applies likewise for the above-mentioned pleated filter bag. This joint can be present for example also on several or all of the sides of the vacuum cleaner filter bag.

As shown above by way of example, the position of the region subjected directly to a flow or of the regions subjected directly to a flow depends upon the respective geometry of a vacuum cleaner filter bag and also possibly any flow dividers or deflection devices for flows which are present, for example deflection devices also being able to be fitted on the corresponding vacuum cleaners or connection pieces which are introduced into the filter bag and hence not on the vacuum cleaner filter bag. The choice of the joined region or the position of the region or regions subjected directly to a flow must hence be determined and established separately for each type of vacuum cleaner filter bag.

Preferably, the staple fibres of the nonwoven fibre layer have a length between 30 and 250 mm, preferably between 50 to 150 mm.

Staple fibres, by way of example, are thereby selected from the group consisting of split fibres, electrostatically charged staple fibres, natural fibres, chemical fibres and/or crimped fibres, the crimped fibres preferably having different spatial structures, preferably of the zigzag, undulating and/or spiral type and/or being selected from the group consisting of mechanically crimped fibres, autocrimped fibres and/or bicomponent fibres.

Preferably, the basis weight of the at least one nonwoven fibre layer is between 10 and 200 g/m², in particular between 20 to 100 g/m².

Alternatively or additionally hereto, the basis weight of the scrim can be at least 3 g/m².

In particular, the filter material comprises at least three filter material layers, a nonwoven fibre layer being disposed between two scrim layers.

If necessary, it is possible that the filter material comprises at least four, preferably at least five, filter material layers, at least one further filter material layer, selected from the group consisting of fine filter layers, paper, nonwoven material and/or nanofibers, being included in addition to the three previously mentioned filter material layers. This further filter material layer is thereby disposed preferably on the outflow side on the filter bag.

For example, a corresponding retaining plate for a respective type of vacuum cleaner can likewise be fitted at the inlet opening. Particularly preferred retaining plates which are suitable for the purposes of the present invention are mentioned for example in the European patent application with the application number 11 010 202. With respect to possible embodiments of preferred retaining plates for the present invention, reference is made to this patent application.

As is evident from the above embodiments, it is necessary in particular to enable as precise a determination as possible of the position of the region subjected directly to a flow in order to be able to fit there a reliable joint of the individual material layers of the filter material. The position of the region subjected directly to a flow thereby depends not only upon the geometric nature of the vacuum cleaner filter bag but also upon deflection devices which are possibly present and deflect an incoming air flow into the interior of the vacuum cleaner filter bag in its direction or flow dividers which can subdivide for example an incoming air flow into at least two partial flows. If necessary, deflection devices can also be present on the corresponding vacuum cleaners, for example correspondingly configured connection pieces which do not blow the flow into the interior of the bag in a straight line through the inlet opening of the vacuum cleaner filter bag.

Further influencing factors are for example likewise the type of filter material, in particular of fibre nonwoven:
Fibre nonwoven fabric made of staple fibre
   grammage of the nonwoven fibre layer
   length of the staple fibre
   diameter of the staple fibre
   geometry of the staple fibre (straight, with crimp)
   material of the filaments
Fibre nonwoven fabric made of filaments
   grammage of the nonwoven fibre layer
   diameter of the filaments
   geometry of the filaments (straight, with crimp)
   material of the filaments

Likewise, the manner in which the surface area is subjected to a flow plays a role which depends in particular upon:
diameter of the connection piece
direction of the inflow (banana connection piece, return valve)
inflowing quantity of air (motor power)
bag geometry
bag folding/bag unfolding
flow dividers present in the bag (dividing and or deflection of the flow)

The present invention therefore likewise provides a method for determining the region or regions of the filter bag subjected directly to a flow by an air flow entering through the inlet opening into the interior of a filter bag for a vacuum cleaner and in which a filter bag comprising a filter material which comprises at least three filter material layers, at least one layer of which is a scrim and at least one layer a nonwoven fibre layer comprising staple fibres and/or filaments, and also an inlet opening introduced in the bag is inserted into a vacuum cleaner suitable for the filter bag and air is suctioned into the filter bag via the inlet opening for 5 minutes at the highest possible power setting of the vacuum cleaner.

Thereafter, the filter bag is removed from the vacuum cleaner and the inside of the filter bag is examined. Those regions which have visually detectable damage are thereby defined as region subjected directly to a flow or, in the presence of a plurality of damaged surfaces, as surfaces subjected directly to a flow.

In the case of the determining method according to the invention, a quasi-identical filter bag for a vacuum cleaner is used, as is described above according to the invention, with the proviso that the filter material of this filter bag has no joints in the surface or, in the presence of a plurality of surfaces, the surfaces subjected directly to a flow. The filter material of this filter bag used for test purposes hence corresponds to the filter material of the vacuum cleaner, as described according to the invention in the remaining regions.

The above testing method is implemented with this filter bag, subsequently the bag is opened (e.g. by removing the circumferential weld seams) and, with reference to the occurring damage, conclusions can be drawn about the surface or surfaces subjected directly to a flow.

Damage can be assumed for example when the nonwoven fibre layer of the filter material has been thinned by the incoming air flow or fibres at this place have been blown away from the nonwoven fibre layer by the air flow. The places of damage hence correspond to the thinned or thickened regions in the filter material. These regions can be determined visually or be determined for example by the average thickness of the filter material being measured before and after implementing the suction test with the vacuum cleaner, as described above. At the places at which a deviation from the average thickness of the filter material can be observed, a damaged region can be assumed. The thickness of the filter material can thereby be determined according to EN ISO 9073-2:1996.

A preferred embodiment in this respect provides that, in the case of the filter bag used for the determining method according to the invention, the at least one nonwoven fibre layer is joined to at least one of the at least two further layers of scrim, with the proviso that, relative to the total throughflow surface of the filter bag, the proportion of compressed surface area of the one or of the sum of the plurality of joints is at most 5% of the throughflow surface of the filter bag and, on average, at most 10 joints per 10 cm² are present, or the at least one nonwoven fibre layer is not joined to the further layers of scrim.

In particular, it is preferred if the vacuum cleaner (if present) is operated without a hose in order to minimise flow losses so as to obtain a result which is as genuine as possible.

According to a further preferred variant of the determining method, also small quantities of dust, sand, toner or combinations hereof can be suctioned into the interior of the vacuum cleaner filter bag during the operating time of the vacuum cleaner. Quantities, by way of example in this respect, are approx. 5 to 15 g, e.g. 10 to 12 g. In particular in the case where toner or a mixture of toner and sand or toner and dust is admitted, visualisation of the consequently achieved damage in the surface subjected directly to a flow is improved.

The knowledge gained from the above-described determining methods can also be used for production of a vacuum cleaner filter bag according to the invention. For this purpose, there is determined firstly, for a respective geometric shape of the vacuum cleaner filter bag according to the above-described method, the place at which the surface subjected directly to a flow or, in the presence of a plurality of surfaces subjected to a flow, the surfaces subjected directly to a flow are situated. At least in these regions and also possibly in additional regions, at least one or a plurality of joints is introduced then into the filter material layer of an otherwise geometrically identical vacuum cleaner filter bag in order there to fix the loose fibres of the nonwoven fibre layer permanently to at least one further scrim layer. The proportion of compressed surface area should thereby be chosen according to the details of patent claim 1.

The present invention is explained in more detail with reference to the subsequently added Figures without however restricting the invention to the specially illustrated parameters. There are thereby shown

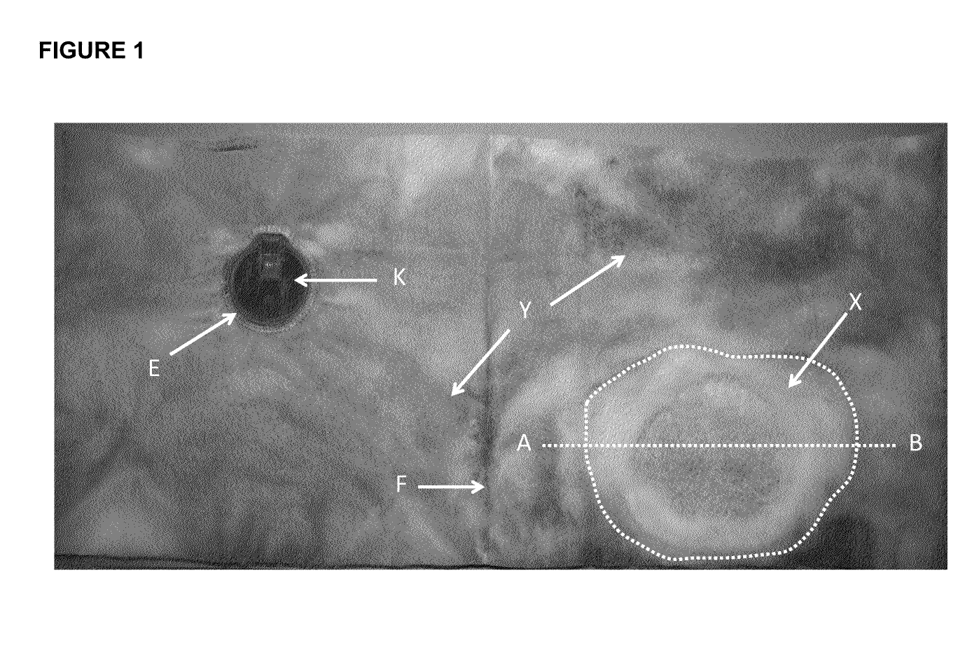

FIG. 1 a flat bag without joints in the surface subjected directly to a flow after implementing the determining method,

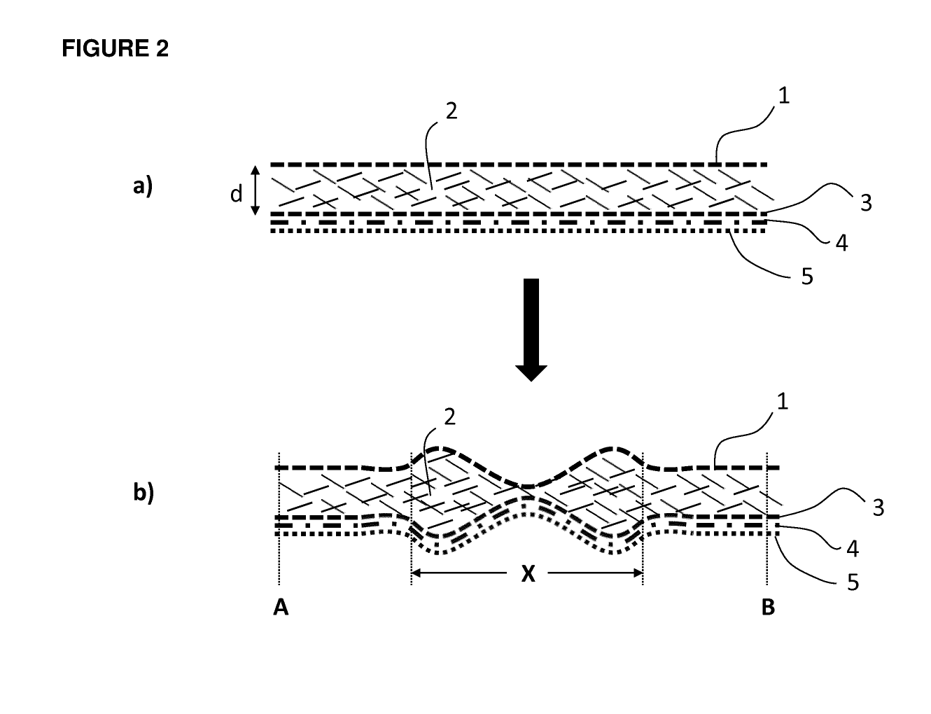

FIG. 2 the construction in principle of the filter material which forms the basis of the filter bag according to FIG. 1,

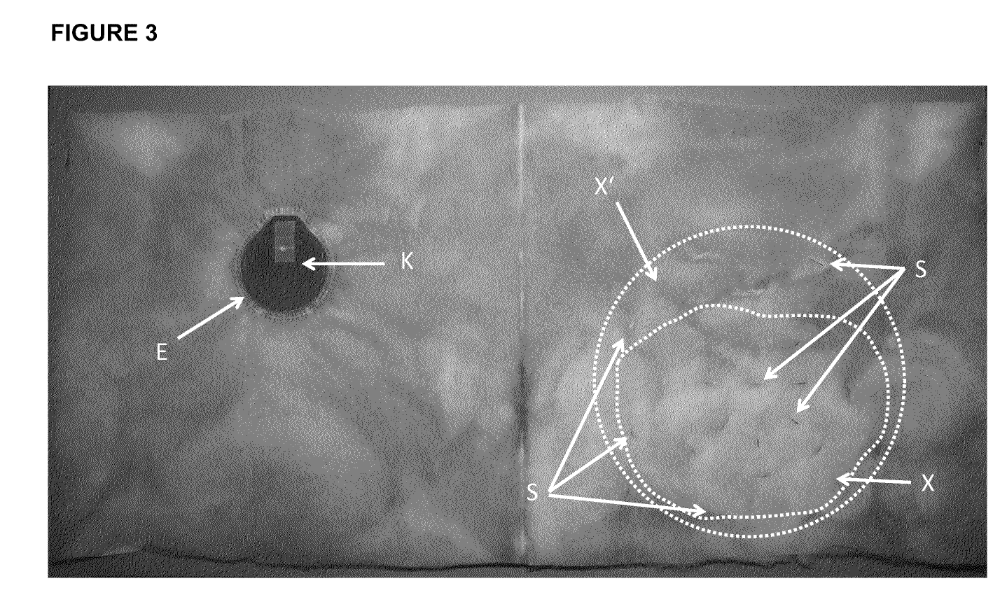

FIG. 3 a flat filter bag according to the present invention after implementing the testing method according to the invention,

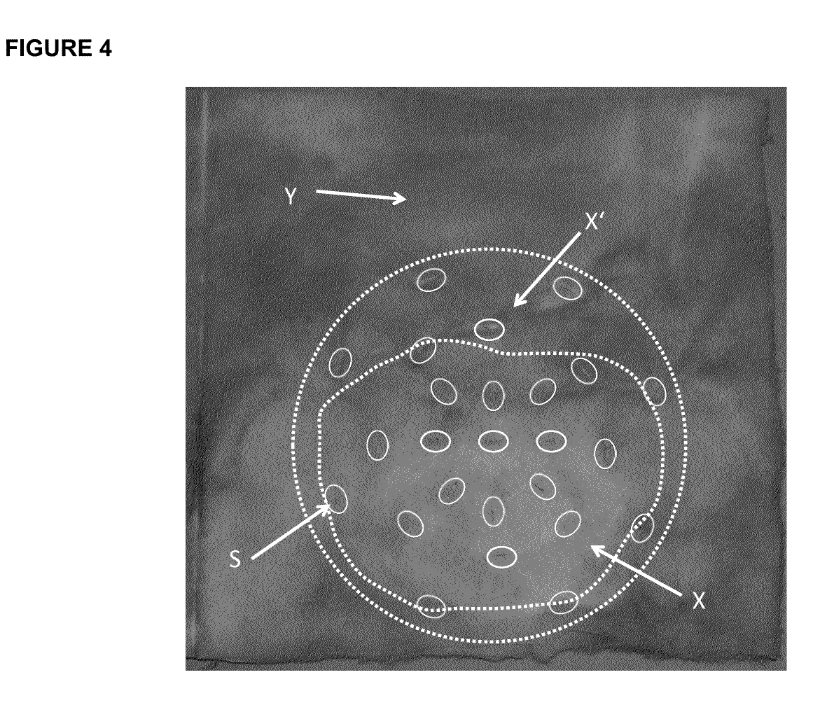

FIG. 4 a detail of the filter bag of FIG. 3,

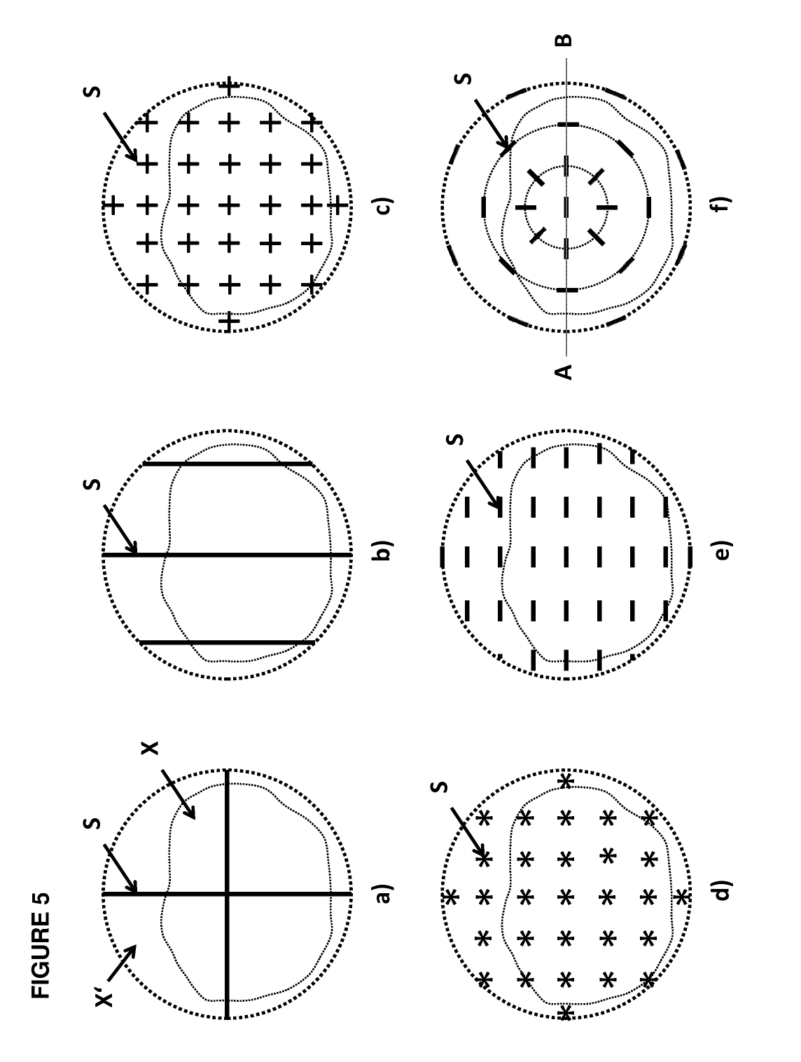

FIG. 5 various possible geometries for joints in the surface subjected directly to a flow according to the present invention, and also

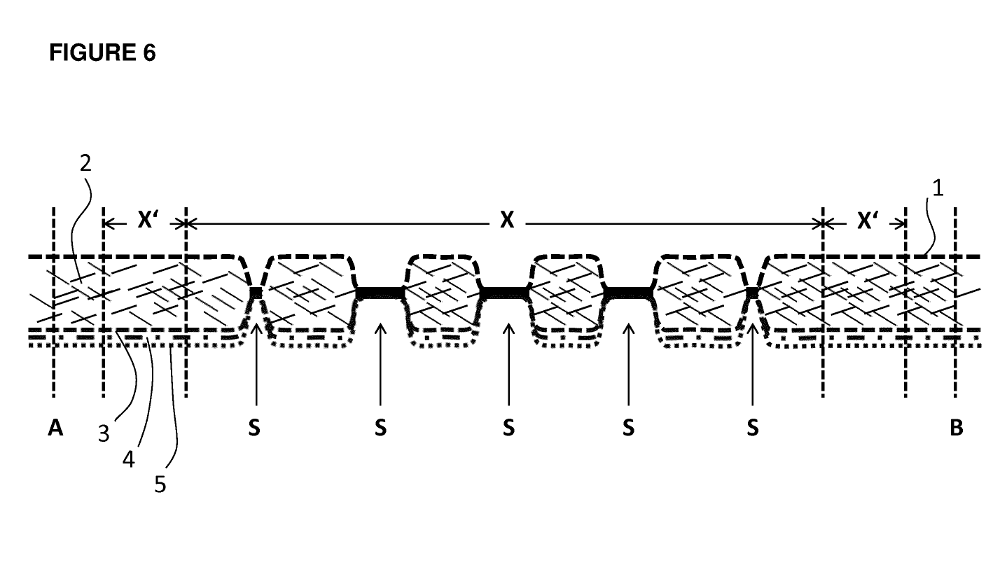

FIG. 6 a cross-section through a sample of joints according to the invention in the surface subjected directly to a flow.

In FIG. 1, a vacuum cleaner filter bag is illustrated, with which the method according to the invention for determining the surface subjected directly to a flow was implemented. The vacuum cleaner filter bag is thereby a flat bag which is welded circumferentially at the edges thereof. In FIG. 1, the cut-out vacuum cleaner filter bag is illustrated, the circumferential weld seam, which was previously present at the edges, was thereby cut off on three sides, merely one weld seam (fold line F) is still present. The two sides illustrated in the Figure on the left and on the right hence represent the front- or rear-side of the filter bag. The front-side has an inlet opening E with a sealing cap K via which the inlet connection piece of the vacuum cleaner can be introduced into the vacuum cleaner filter bag. The right-hand side illustrated in FIG. 1 (to the right of the fold line F) hence represents the rear-side of the vacuum cleaner filter bag. In FIG. 1, a view on the inside of the vacuum cleaner filter bag is indicated, i.e. on the inflow side of the filter material. The filter material of the filter bag illustrated in FIG. 1 thereby consists of 5 layers of filter material, viewed from the inflow side towards the outflow side, namely made of a layer of scrim made of a thermoplastic material, and also a nonwoven fibre layer made of loose, non-joined staple fibres of a further layer of scrim, a meltblown layer and an externally disposed layer of spun nonwoven fabric. With the exception of the regions of the edge-side weld seams (which were removed in FIG. 1 apart from the still present fold line F and also the welding of the sealing flap K at the inlet opening E), the individual layers of the filter material are thereby not joined in the overall surface. With this vacuum cleaner filter bag (in the sealed state), the method for determining the region X subjected directly to a flow was implemented. The vacuum cleaner filter bag was hereby inserted into a vacuum cleaner suitable for this purpose and the vacuum cleaner was operated for five minutes at the highest power setting. For better visualisation of the damage to the filter material, approx. 10 g of a mixture of 10 g mineral dust (AC fine dust) with 1 g toner (black), in portions, was suctioned into the vacuum cleaner filter bag. However, the method can likewise be implemented without suctioning in dust and/or toner. Subsequently, the vacuum cleaner filter bag was removed from the vacuum cleaner and the circumferential welding was removed on three sides in order to examine the occurring damage. It is detectable that the loose fibres of the nonwoven fibre layer were displaced in a region X. The darker inner circular portion illustrated in region X thereby represents a place at which fewer loose fibres are present, these were pressed concentrically to the side by the air flow entering through the inlet opening and hence blown away. Hence the filter material in the interior of the region X is thinned, at the edge of region X it is thickened by a bead of loose fibres. Both shapes illustrate damage to the filter material which it is important to avoid. In the remaining regions Y which are situated outside region X, no such damage could be established. In addition, it is detectable that, contrary to expectations, the region X in which damage occurs is not situated directly opposite the inlet opening E but somewhat diagonally opposite the latter. The surface X subjected directly to a flow, i.e. the region in which visually detectable damage by the air flow of the filter material occurs, is determined as region X which represents the region subjected directly to a flow or the surface subjected directly to a flow. As is evident from FIG. 1, this region has an irregular contour which to a first approximation has an oval shape for the case of the example of the flat bag.

In FIG. 2, a schematic section through the filter material of the vacuum cleaner filter bag used in FIG. 1 is illustrated, FIG. 2a) illustrating a section through the filter material before the method according to the invention for determining the surface X subjected directly to a flow and FIG. 2b) a section along the line A-B illustrated in FIG. 1, i.e. according to the method according to the invention. In FIG. 2a), the undamaged filter material is illustrated. It is detectable that the nonwoven fibre layer 2, which consists of loose, non-joined fibres, is enclosed by two layers of scrim 1 and 3 and hence is fixed. Instead of the scrim layers 1 and 3, also other materials, such as for example nonwoven fabrics etc., can however be used. Likewise, it is possible that one of the layers 1 and 3 represents a netting, the other a nonwoven fabric layer etc. In addition, a meltblown layer 4 and also a layer of spun nonwoven fabric 5 is disposed on the outflow side. The filter material, i.e. the sum of layers 1, 2 and 3, thereby has a specific average thickness d which can be determined according to EN ISO 9073-2:1996, method B. For determining the surface X subjected directly to a flow, now the method presented for FIG. 1 is implemented, in which air is blown into the vacuum cleaner filter bag for 5 minutes at the highest power setting of a vacuum cleaner. In the region in which the air flow impacts directly, i.e. unchecked, upon region X, displacement or blowing away of the loose, non-joined fibres takes place; the fibres are thereby displaced to the side and accumulate in the edge region of the surface X subjected directly to a flow and a space 6 free of fibres is formed. In the centre of the region X subjected directly to a flow, the result thereby is thinning of the non-joined nonwoven fibre layer, whilst increased accumulation of loose fibres takes place in the edges of this region, i.e. a thickening of this region is effected. Both effects are however disadvantageous for a durable operation of the vacuum cleaner filter bag and hence for the service life: in the centre of the region X, increased permeability for dust thereby takes place whilst an increased tendency for clogging of the filter material occurs in the edge regions of surface X due to the increased thickness d of the filter material. The exact position of the region X subjected directly to a flow can be determined visually. Alternatively the boundary of region X can also be determined by determining the regions from which, starting from the remaining regions Y, an increase or a decrease in the average layer thickness d of the filter material in the remaining regions can be noted. For this purpose, again the above-indicated testing standard can be used to determine the layer thickness (EN ISO 9073-2:1996, method B).

In FIG. 3, a vacuum cleaner filter bag according to the invention is illustrated which, in the surface X subjected directly to a flow and also in an additional surface X′ which is disposed around the surface X subjected directly to a flow, has bar-shaped weld seams S. With the vacuum cleaner filter bag illustrated in FIG. 3, a testing method which was also illustrated for the vacuum cleaner filter bag was likewise implemented. This vacuum cleaner filter bag was also inserted in a vacuum cleaner and air was suctioned into the vacuum cleaner filter bag for 5 minutes at the highest power setting of the vacuum cleaner, and also for improved viewing of any possibly occurring damage, approx. 10 g of a mixture of 10 g mineral dust (AC fine dust) with 1 g toner (black). The vacuum cleaner filter bag illustrated in FIG. 3 is formed from the same filter material as the vacuum cleaner filter bag according to FIG. 1 and has the same dimensions or measurements.

In the case of the vacuum cleaner filter bag according to the invention according to FIG. 3, bar-shaped welded joints were introduced in the region X subjected directly to a flow, as determined for the vacuum cleaner filter bag in FIG. 1, in which welded joints all of the five layers of the filter material were joined. These welded joints are detectable in FIG. 3 as black lines and characterised with the reference number S. In addition, welded joints S were introduced in an additional region X′ which is disposed around the region X subjected directly to a flow. It is detectable that, merely as a result of these welded joints S in the region X subjected directly to a flow and also welded joints S introduced possibly in a region X disposed in addition around the region X subjected directly to a flow are entirely adequate for preventing damage which occurs due to the direct impact of the air- or particle flow onto the surface X subjected directly to a flow (see FIG. 1). The proportion of compressed surface area of the welded joints S is thereby, in the case of the example of FIG. 3, approx. 0.7% both in the region X subjected directly to a flow and in the additional region X′. In the remaining regions of the vacuum cleaner filter bag, no further welded joints of the individual layers of the filter material are introduced (with the exception of the circumferential welded joint or the welded joint in the region of the inlet opening E for fixing the retaining plate K). According to the present invention, the number of welded joints or the proportion of compressed surface area thereof can hence be reduced to an absolutely necessary minimum, which leads to an extremely long service life of the vacuum cleaner filter bag.

In FIG. 4, an enlarged receiving means of the rear-side of the vacuum cleaner filter bag is shown, as illustrated in FIG. 3. The individual welded joints S present, which are made visible by the white oval edges, are illustrated.

In FIG. 5, various possible weld patterns are illustrated, which patterns can be introduced in the region X subjected directly to a flow or in an additional region X′ around the region X subjected directly to a flow. As illustrated in FIG. 5a), a possible welded joint can be configured for example as a cruciate welded joint S which is formed continuously by the surface X subjected directly to a flow and by the additional region X′. Likewise, parallel-guided welded joints S (see FIG. 5b) can be possible. Furthermore, cruciate welded joints (FIG. 5c), star-shaped welded joints (FIG. 5d) or bar-shaped welded joints (FIG. 5e) are possible. It is merely crucial thereby that the proportion of compressed surface area of the weld pattern, i.e. the surface which, due to the weld seam or the sum of the surfaces of the individual weld seams, relative to the total surface of the region X subjected directly to a flow and possibly the additional region X′, lies within the dimensions as defined in patent claim 1.

A particularly preferred embodiment of a weld pattern is illustrated in FIG. 5f). This weld pattern also forms the basis of the vacuum cleaner filter bag according to the invention as was presented in FIG. 3 or 4. The bar-shaped weld seams 5 thereby lie on concentric circles, in addition a bar-shaped weld seam is disposed in the centre of the concentric circles.

In FIG. 6, a sectional image along the line A-B of FIG. 5f) is illustrated. The filter material thereby consists again of the scrim layers 1 and 3 and also of the nonwoven fibre layer 2 applied therebetween and also the meltblown layer 4 and the spun nonwoven fabric layer 5. In the region X, respectively bar-shaped welded joints S are thereby present, at which all of the layers of the filter material 1 to 5 are joined. The welded joints are thereby introduced preferably by means of an ultrasonic welding method. Also in the additional regions X′, welded joints can be present (see FIG. 5f), these welded joints S are however not illustrated in FIG. 6 with reference to the chosen section A-B. The welded joints S present in the region of the surface X subjected directly to a flow and also possibly in the additional surface X′ thereby endow the filter material with sufficiently high intrinsic strength so that, during operation of the vacuum cleaner filter bag, displacement of the loose fibres of the nonwoven fibre layer 2 can be effectively prevented from taking place and hence damage (see also FIG. 1) can be effectively prevented.

1. A filter bag for a vacuum cleaner comprising:
a bag made of a filter material which comprises at least three filter material layers, at least one layer of which is a scrim and at least one layer is a nonwoven fibre layer comprising staple fibres or filaments;
an inlet opening introduced in the bag,
the filter material of the filter bag in at least one region, which constitutes or constitute at most 20% of a throughflow surface of the filter bag, and also possibly in an additional region or additional regions which surrounds or each surround the region or respectively the at least one region, the additional region or the additional regions constituting at most 80% of the surface of the at least one region or respectively of each the region, having one or more joints, wherein the at least one nonwoven fibre layer is joined at least to one of the at least two further layers of scrim so that, during operation of the filter bag, a permanent fixing of the staple fibres or filaments of the nonwoven fibre layer to the at least one of the at least two further layers of scrim is ensured,
wherein a proportion of compressed surface area of the one or more joints in the at least one region or in each of the regions and also possibly in the additional region or in the additional regions, is of 0.1 and 40% and is greater than in remaining surfaces.

2. The filter bag according to claim 1, wherein the region or the regions is or are disposed in one region or regions subjected directly to a flow by an air flow entering through the inlet opening into an interior of the filter bag.

3. The filter bag according to claim 1, wherein the proportion of compressed surface area of the one or more joints in the region or in each of the regions and also possibly in the additional region or in the additional regions is of 0.25 and 20%.

4. The filter bag according to claim 1, wherein the additional region or the additional regions constitutes or constitute 10 to 80% of the surface area of the region or respectively of the regions.

5. The filter bag according to claim 1, wherein the additional region or the additional regions have a circular or oval configuration or corresponds or correspond to the geometric shape of the region or of the regions.

6. The filter bag according to claim 1, wherein the at least one nonwoven fibre layer is joined to at least one of the at least two further layers of scrim in the remaining surfaces, wherein, relative to a total throughflow surface of the filter bag in the remaining surfaces, the proportion of compressed surface area of the one or of a sum of the one or more joints is at most 5% of a throughflow surface of the filter bag in the remaining surfaces and, on average, at most 10 joints per 10 cm² are present, or the at least one nonwoven fibre layer is not joined to the at least two further layers of scrim.

7. The filter bag according to claim 1, wherein in the region or in the regions and also possibly in the additional region or in the additional regions, the one or more joints is configured to be bar-shaped, cruciate, star-shaped, punctiform or linear or circular.

8. The filter bag according to claim 1, wherein in the region or in the regions and optionally in the additional region or in the additional regions, a plurality of punctiform or bar-shaped joints is present, which are disposed on a plurality of concentric circles.

9. The filter bag according to claim 1, wherein in the remaining surfaces, on average at most 5, joints per 10 cm² are present or a proportion of compressed surface area of the joints in the remaining surfaces is at most 2%, of a surface of a throughflow surface of the filter bag in the remaining surfaces.

10. The filter bag according to claim 1, wherein the scrim has a basis weight of 3 to 50 g/m².

11. The filter bag according to claim 1, wherein the scrim is selected from the group consisting of nettings, perforated foils, weldable paper and nonwoven fabrics.

12. The filter bag according to claim 1, wherein the filter bag in the region or in the regions and also possibly in the region or in the additional regions, has no impact-protectors or reinforcing inserts.

13. The filter bag according to claim 1, wherein the joint or the joints are welded joints or are produced by sewing together the nonwoven fibre layer and at least one scrim layer.

14. The filter bag according to claim 1, wherein the filter material comprises, on the outflow side, at least one further material layer.

15. The filter bag according to claim 1, wherein in the region of the joint or of the joints, all of the layers of the filter material are joined.

16. The filter bag according to claim 1, wherein the inlet opening has a deflection device via which a flow direction of an air flow entering into an interior of the filter bag is changed or has a sealing flap for the inlet opening.

17. The filter bag according to claim 1, wherein the filter bag comprises at least one flow divider which subdivides an air flow entering through the inlet opening into an interior of the filter bag into at least two partial flows with a different main flow direction, the filter material, in each region of a respective partial flow subjected directly to a flow and also possibly in addition in an additional region which surrounds the region subjected directly to a flow, has the one or more joints.

18. The filter bag according to claim 1, wherein the filter bag
a) is a flat filter bag which is formed by two material layers made of the filter material which are welded circumferentially at edges of the filter material, the inlet opening being provided in one material layer, or
b) is a side gusseted filter bag, or
c) is block bottom bag in which the inlet opening is provided in a block bottom, or
d) is a pleated filter bag.

19. The filter bag according to claim 1, wherein the staple fibres of the nonwoven fibre layer have a length between 30 and 250 mm.

20. The filter bag according to claim 1, wherein the inlet opening has a retaining plate.

21. A method for determining a region or regions of a filter bag subjected directly to a flow by an air flow entering through an inlet opening into an interior of the filter bag for a vacuum cleaner, the filter bag comprising
a filter material which comprises at least three filter material layers, at least one layer of which is a scrim and at least one layer a nonwoven fibre layer, comprising staple fibres or filaments,
an inlet opening introduced in the bag, the method comprising:
inserting the filter bag into a vacuum cleaner suitable for the filter bag and suctioning air into the filter bag via the inlet opening for 5 minutes at a highest possible power setting of the vacuum cleaner,
and identifying the region or regions which have visually detectable damage as the region subjected directly to a flow or regions subjected directly to a flow.

22. The method according to claim 21, wherein the at least one nonwoven fibre layer is joined to at least one of the at least two further layers of scrim, wherein, relative to a total throughflow surface of the filter bag, a proportion of compressed surface area of the one or of a sum of the one or more joints is at most 5% of a throughflow surface of the filter bag and, on average, at most 10 joints per 10 cm² are present, or the at least one nonwoven fibre layer is not joined to the at least two further layers of scrim.
